(19) United States
(12) Patent Application Publication
(10) Pub. No.: US 2014/0281367 A1
(43) Pub. Date: Sep. 18, 2014

(54) ADDRESS CALCULATION FOR RECEIVED DATA

(71) Applicants: Mark W. Johnson, Austin, TX (US); Robert Bahary, Arlington Heights, IL (US)

(72) Inventors: Mark W. Johnson, Austin, TX (US); Robert Bahary, Arlington Heights, IL (US)

(21) Appl. No.: 13/830,701

(22) Filed: Mar. 14, 2013

(51) Int. Cl. G06F 12/06

(52) U.S. Cl. CPC G06F 12/06
USPC 711/218

(57) ABSTRACT

A method of address generation and corresponding index generator for one or more locations in a buffer with received data, determining an offset address for a specific data element in the buffer; calculating a correction factor in parallel with the determining an offset address; and providing an address for the specific data element in the buffer by combining the offset address and the correction factor, the correction factor adjusting for any impact on the offset address resulting from null elements.

### FIELD OF THE INVENTION

This invention relates in general to communications systems and more specifically to techniques and apparatus for determining an address for specific data in a buffer in which received data is stored.

### BACKGROUND OF THE INVENTION

Transmitting information over a communications link is known. In current systems large amounts of digital data are transmitted over communications links, such as wireless communications links. In the interests of system performance, as may be reflected in one or more parameters, such as system capacity, transmission efficiency, or error rates suitable to support contemplated services, these communications links often utilize more complex channel coding schemes. Some systems use concatenated coders and one or more steps of interleaving to provide suitable performance for services to, e.g., wireless devices, including mobile devices.

In some of these systems various null data may be added at one or more steps in the channel coding when transmit data is being formulated. In the interests of channel capacity this null data is typically not transmitted. The receiver must determine where, within the received information stream, specific data is located and in so doing must account for the impact of null data.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 depicts in a simplified and representative form, a high level diagram of a receiver with an address generator and a buffer for received data in accordance with one or more embodiments;

FIG. 2 depicts in a simplified and representative form, a high level diagram of an address generator suitable for use in FIG. 1 in accordance with one or more embodiments;

FIG. 3-5 in a representative form, show more detailed diagrams of respective portions of an offset address generator suitable for use in FIG. 2 in accordance with one or more embodiments;

FIG. 6 depicts in a representative form, a more detailed diagram of a fillbit portion of a correction factor calculator for determining a correction factor suitable for use in FIG. 2 in accordance with one or more embodiments;

FIG. 7-9 depict in a representative form more detailed diagrams of respective portions of the correction factor calculator suitable for use in FIG. 6 in accordance with one or more embodiments;

FIG. 10 depicts a more detailed diagram of an output portion of a correction factor calculator in accordance with one or more embodiments; and

FIG. 11 shows a flow chart of processes executed by a method of address or index generation that may be used in conjunction with the FIG. 2 system in accordance with one or more embodiments.

### DETAILED DESCRIPTION

Various embodiments in accordance with the present disclosure concern address generation for a buffer, e.g., address calculation for locations of received data in the buffer, and more specifically techniques and apparatus for providing an address for specific data elements in a buffer, where the address is arranged and constructed to account for one or more missing elements in the buffer. More particularly various inventive concepts and principles embodied in methods and apparatus for address or index generation or calculation which correct for, e.g., null data or the like, will be discussed and disclosed.

The address calculation or generation of particular interest may vary widely but include those suitable for use in LTE (Long Term Evolution) systems as defined in one or more air interface standards developed by 3GPP (3^{rd} Generation Partnership Project). In systems, equipment and devices that employ, e.g., the LTE E-UTRA (Evolved Universal Terrestrial Radio Access) channel coding, address or index calculation apparatus and methods can be particularly advantageously utilized, provided they are practiced in accordance with the inventive concepts and principles as taught herein.

The instant disclosure is provided to further explain in an enabling fashion the best modes, at the time of the application, of making and using various embodiments in accordance with the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions.

Much of the inventive functionality and many of the inventive principles are best implemented with or in integrated circuits (ICs) including possibly application specific ICs or ICs with integrated processing controlled by embedded software or firmware. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts of the various embodiments.

Referring to FIG. 1, a simplified and representative high level diagram of a receiver with an address generator and a buffer for received data in accordance with one or more embodiments will be briefly discussed and described. As depicted, FIG. 1 illustrates a receiver including a radio frequency and demodulation portion 101 that operates as is generally known to receive a radio frequency signal and process that signal including one or more of amplification, filtering, frequency translation, and basic demodulation.

Following those functions is a decoder 103 that operates for decoding received data and that typically includes processing to decode channel coding that was done prior to transmission. For example this often includes decoding or de-interleaving for data interleaving and other coding (interleaving, block coding, convolutional coding, turbo coding etc.) In the decoder 103 received data or received information from the demodulator 101 is loaded into a buffer 105 or data buffer in the sequence as received and demodulated. For various reasons, e.g., non-transmitted elements or null data elements as noted above or interleaving, the location of a specific data element in the buffer is not necessarily known until calculated or determined.

This index or address generation or calculation is done by the address generator 107 as will be further described below. By having an index or address for each data element in the buffer, particular data elements can be retrieved and further processed as the data is needed. An alternative might be to reorder the data in the buffer by actually changing the data locations in the buffer and then reading the data out in a sequence. For de-interleaving, this may require a plurality of reads and re-writes. As a rule, this may consume extra battery and processor capacity, which in portable applications with finite power sources is undesirable. Given this address or index a specific data element can be obtained from a corresponding location in the buffer 105. After decoding, the information corresponding to the received data is passed on to an additional processing, turbo decoding, and output function 109 that does whatever is needed to make the information useful. It is understood that many functions are performed by the decoder 103 and these may be accomplished in total or in part by a processor executing software or a combination of software and hardware. The discussions below will focus on the inventive aspects of the address generation and generator processes and apparatus.

Referring to FIG. 2, a simplified and representative high level diagram of an address or index generator suitable for use in the decoding or decoder 103 of FIG. 1 in accordance with one or more embodiments will be briefly discussed and described. FIG. 2 illustrates at a high level, the basic functions and operations associated with the address or index generator 107. In FIG. 2, an offset address function 203 or generator operates for calculating or determining an offset address at 205 for a specific data element, as specified at 207, in the buffer 105. Additionally a correction factor function 209 or calculator operates for calculating or determining a correction factor at 211 separately from and often in parallel with the determining an offset address. Given the offset address at 205 and correction factor at 211, a combiner 213 provides the address or index for the corresponding specific data element at 215. More particularly, the combiner 213 operates for providing an address or index for the specific data element in the buffer 105 by combining the offset address and the correction factor, the correction factor adjusting for any impact on the offset address resulting from null data elements (variously referred to as null elements, filler bits or filler elements, etc.).

It is noted that in certain embodiments of the method of address or index generation or the address or index generator that the determining an offset address and the calculating a correction factor each utilize one or more of the same parameters (shown at 217). In some embodiments, the one or more of the same parameters further comprises parameters specified in accordance with an air interface standard (e.g., bit stream identifier, constants at 219 that depend on the air interface). In still further embodiments, the one or more of the same parameters can comprise parameters in accordance with a message received from an air interface communication, e.g., number of null elements or data size (e.g., bits, symbols, etc.). This information along with other overhead can be received via an over the air message that corresponds to the received data.

As suggested above and further discussed below, some embodiments of the method of or apparatus for address generation for one or more locations in a buffer with received data includes calculating a correction factor at 211 that further comprises using one or more constants at 219 that correspond to a count of null data elements when the specific data element is in a, respective, one or more predetermined locations. In some embodiments, the determining an offset address and calculating a correction factor each use a common or first control signal shown at 221.

As will be described below, in some embodiments, the calculation or determination or generation of an offset address further comprises specifying the position of the specific data element in a sequence (at 207) and a total count of null data elements (part of parameters at 217) and finding the offset address as though each of the null data elements were in the buffer. In some embodiments the determining or generating an offset address at 205 further comprises selecting the sequence from a plurality of sequences where these sequences are specified in, e.g., an air interface standard.

Referring to FIG. 3-5 sequentially, more detailed diagrams of respective portions of an offset address generator suitable for use in FIG. 2 in accordance with one or more embodiments; will be discussed and described. FIG. 3 illustrates a front end or first portion of the offset address generator (e.g., offset address generator 203) and generation. In some embodiments as we will discuss, the determining an offset address further comprises specifying the position of the specific data element in a sequence and a total count of null data elements and finding the offset address as though each of the null data elements were in the buffer

This explanation of offset address generation or portions thereof, etc. will assume the E-UTRA standards (ETSI TS 136 212 V9.1.0 (2010-04)) and in particular section 5.1.4 et. sequence (or similar standards) are being implemented. The section 5.1.4 explains rate matching and the interleaving results and various requirements for encoding data, and is hereby incorporated herein by reference. This description is focused on decoding data that has been encoded. In the standard, the number of null elements or dummy bits is denoted as N_D, where this number is determined to be the unfilled portion of a matrix or sub block matrix that has 32 columns (C) and a number of rows (R) just large enough to fit the number of data elements or bits that are in the payload (D), i.e., D<R×C, where R is the smallest integer where the inequality holds true. R×C is also referred to as K_Pi in some of the discussion below. K_Pi is a number that has 13 binary digits to represent up to 6176 indexes decimal. Given the inequality, N_D=R×C−D and this will vary from 0 up to 31 dummy or null bits or elements (up to one less than number of columns) The N_D dummy bits or data elements are placed in the first row in the first N_D locations. N_D and K_Pi are some of the parameters 217 and these are provided by an air interface communication or determined by information from an air interface communication.

Further, in the E-UTRA standard, a turbo coder provides three bit streams denoted as d(0)k (the systematic or actual data stream), d(1)k (first parity bit stream from a turbo coder, and d(2)k (second parity bit stream from the turbo coder), where the k ranges from 0 (first d element) to D−1 (last d element). Each of these three bit streams are provided to or may be viewed as organized in accordance with a respective matrix with a first row prefixed with N_D dummy bits.

Again, referring to FIG. 3, the dk index at 303 is added to N_D at 305 by a summer 307. As noted above, if the D data elements or bits does not fit into the interleaver matrix completely (N_D is non zero), the first row of the matrix is prefixed with N_D dummy bits before the interleaving process. Therefore, the first bit of user data at spec index k=0 (dk=0) is at N_D. In this manner, the dk index is converted to a v index=dk+N_D by the summer 307.

In the E-UTRA standard, section 5.1.4.1.1 defines how the data from each stream is inserted into an interleaver matrix. This insertion is defined twice: once for d(0)k and d(1)k and then a different algorithm is given for d(2)k. A multiplexer 309 controlled by the bit stream at 311 selects the appropriate index. Thus the determining an offset address further comprises selecting the sequence or bit stream from a plurality of sequences or bit streams. In FIG. 3, bit stream at 311 can be =0, 1, or 2 where this corresponds to the turbo encoder bit streams d(0, 1, or 2)k. So for bit streams 0 and 1 we simply pass the index v to y at 312. But for bit stream 2, (d(2)k) we need to make an adjustment. In section 5.1.4.1.1 a formula is provided and this formula does a shifting of the values for d(2)k. So when bit stream is 2 and vk=0, we get index (K_Pi−1), vk=1 we get index 0, vk=2 we get index 1, etc.

In FIG. 3, this is accomplished by the multiplexer 313 as controlled by the index vk and the comparator 315. When vk=0, the multiplexer 313 is controlled to select K_Pi (R×C) and then a subtractor 319 takes away 1 and we have K_Pi−1 and for vk=1, vk is selected by the multiplexer 313 and 1 is subtracted providing v−1=0, for vk=2 with get v−1=1, etc. as the respective y index values at 312. In general the output of the subtractor 319 is v−1 mod K_Pi. The index value at the output of subtractor 319 is moved to y at 312 (the output of multiplexer 309) when the bit stream is set to 2, i.e., input 2 of the multiplexer is selected.

Referring to FIG. 4 a middle portion of the offset address generator and generation is illustrated. In the encoder data in preparation for transmission is written into the matrix column-wise. So v=0 is written into the first column, v=1 is written into the 2^{nd}column, etc. Since there are always 32 columns, the column is given by the first 5 least significant bits (lsbs) of the index v. Which row the data is written is then the upper order bits (msbs) (12:5) of the index v.

After the data is written into the columns of the matrix in the encoder, the columns of the matrix are permuted (changed location) given the following information (see table 5.1.4-1). For columns 0, 1, . . . , 31, re-position or relocate these columns to the following respective locations 0, 16, 8, 24, 4, 20, 12, 28, 2, 18, 10, 26, 6, 22, 14, 30, 1, 17, 9, 25, 5, 21, 13, 29, 3, 19, 11, 27, 7, 23, 15, 31. A pattern can be found in these numbers. For example original column 1, designated 00001 binary with the designation reversed to read 10000, is decimal 16, i.e., original column 1 is moved to column 16 in the matrix. As another example original column 5, designated 00101 reversed is 10100 binary or decimal 20, so original column 5 is moved to column 20 in the permuted matrix. Interestingly, column 4, 00100 when reversed to read 00100 remains column 4. Realizing the pattern can be generated by reversing the order of the v[4:0] or 5 least significant bits (a swizzle) we can determine the index of the permuted column.

In FIG. 4, y from FIG. 3 at 312 is the input index. The five lsbs are selected 403 and routed to the swizzle operation 405 (reverse order of bits) with the output of the swizzle operation 407 being designated pcol[4:0]. This value is supplied to the correction factor calculation as will be discussed below.

The interleaver in E-UTRA as in many air interface standards works by writing data in column-wise (data values placed in 0^{th}, 1^{st}, 2^{nd}, . . . , 31 columns in row 1 and then repeated for row 2, etc.), but reading the data out row-wise (all R rows from col 0, then all rows from col. 1, . . . , 31). To reflect this conversion, using multiplier 409, multiply pcol[4:0] with R at 408, the number of rows in the matrix, and add row[7:0], selected at 410, using summer 411.

In the E-UTRA standard, section 5.1.4.1.2 defines how data bits or samples are put in a circular buffer, where the circular buffer is typically 3K_Pi in length. The first K_Pi locations are filled with the bit stream 0, (d(0)k) data and thereafter the circular buffer is filled with alternating data from bit stream 1 (even locations) and 2 (odd locations).

So in the diagram, we show that the index from summer 411 is unchanged at 413 (corresponds to bit stream 0). The index from summer 411 is multiplied by 2 at multiplier 415 and then K_Pi (number of bits in a bit stream) at 317 (see FIG. 3) is added at adder 417 to yield an even index at 419 (corresponds to bit stream 1). This index at 419 has a one added by adder 421 to yield an odd index at 423 (corresponds to bit stream 2). Multiplexer 425 is controlled by the bit stream indication at 311 (same as FIG. 3) to select the input at 413 if bit stream is set to 0, the input at 419 if bit stream is set to 1, and the input at 423 if the bit stream is set to 2, where the selection shows up as index i at 427 with the i index being a 15 bit number. This is another example where the offset address determination or calculation comprises selecting the sequence or bit stream from a plurality of sequences or bit streams (any one of three sequences). Or in other words, for bit streams 1 and 2, we add K_Pi (the number of bits in a bit stream) since the index for bit streams 1 and 2 must skip over all of bit stream 0. For bit steam 1 we do all the evens and for bit stream 2 we do all the odds. (Even: input*2. Odd: input*2+1).

Referring to FIG. 5, the final portion of the offset address generator and generation along with the combiner is illustrated. In the E-UTRA standard, section 5.1.4.1.2 defines a parameter k0 and this is the starting point, in the circular buffer, of the data to be transmitted. It is understood that the data as defined above goes into this circular buffer. The k0 parameter depends on various air interface parameters (redundancy factors, R, etc.) where some depend on a particular transmission. Thus k0 depends in part on air interface standards and in part on an over the air transmission. The circular buffer is defined to be Ncb elements or bits in size and this is either 3*K_Pi (as suggested above which is also referred to Kw) or a floor (N_IR/C). Kw is 3*K_Pi, which is a circular buffer consisting of all 3 bit streams. N_IR/C is a measure of how much space the system uses to saves revisions in its soft-buffer. So Ncb is a truncation of the circular buffer for very large data-sets.

By way of example, if k0 is 5, then the first transmitted bit would be i=5. If i=0, i−k0=−5, which means that the 0th data value is at the very end of the circular buffer indexing. You can think of it as (i−k0) modulo Ncb. So if the value is negative, modulo Ncb means we add Ncb to put the number in the range 0 to Ncb−1. Thus in some embodiments, the determining an offset address further comprises using a starting point, e.g., k0 for received data to selectively adjust the offset address. Thus in these embodiments, the determining an offset address further includes compensating for a starting point for transmitted data to selectively adjust the offset address associated with the received data.

This is reflected in FIG. 5 where the index I at 427 has k0 subtracted by subtractor 503, with i−k0 at the output 505. This i−k0 index has Ncb added to it at summer 507. Thus the multiplexer 509 has i−k0 at one input 505 and i−0+Ncb at the other input 511. If i−k0 is negative (assessed by comparator 513 at control output 515), we control the multiplexer 509 to pass the signal at 511, i−k0+Ncb and if i−k0 is positive the multiplexer 509 is controlled to pass the signal, i−k0, at 505. Thus the output signal of comparator 513 is a control signal or common control signal that is used in the offset address derivation or calculation and is supplied to and used as well in the correction factor determination. The output of multiplexer 509 is or corresponds to the offset address (if one exists) for the specific data element that was specified, dk, at 303.

In the E-UTRA standards among other air interface standards, in the interest of channel capacity, etc., Null or dummy bits are not transmitted. So while the circular buffer includes Null or dummy bits or symbols, these are skipped over when data transmission occurs and thus the received data does not include these Null bits. Hence address or index generation has to account for this. The correction factor logic or calculator, discussed below, generates or determines a correction factor provided at 519.

The combiner 520 provides an address for the specific data element in the buffer by combining the offset address at 517 and the correction factor at 519, with the correction factor adjusting for any impact on the offset address resulting from null data elements. More specifically, a subtractor 521 subtracts the correction factor from the offset address at 517 to account for any possible impact on a given index value from one or more Null bits with the output of the subtractor 523 providing the address (if one exists).

The providing an address for the specific data element in the buffer by combining the offset address and the correction factor in some embodiments further comprises determining whether a possible address at 523 corresponds to a transmitted data element. This also uses the combiner 520 in some embodiments. As above noted, there may be a potential truncation of the circular buffer, i.e., for large data sets, where Kw or 3*K_Pi exceeds Ncb. Therefore, the index at 523 could actually be for a data value that was not transmitted, i.e. a bit stream 1 or 2 value (parity values from the turbo encoder). We compare the index (before accounting for the starting point k0), i.e., index i at 427 with Ncb at 525 using comparator 527. This indicates whether the index at 523 was used in building the circular buffer. If this index was less that the size of the circular buffer (<Ncb), a multiplexer 529 is controlled to pass the index at 523 to the output 531 and this becomes the index or address for the specific data element in the buffer with received data as specified by dk. If the index at 427 is equal to or greater than Ncb, it was not used and the corresponding data element or bit was never transmitted. In this instance a flag is set at 533 for use in any downstream decoding and a sentinel is set (e.g. all “1”s) at output 531 to let down-stream logic know the data element or bit wasn't transmitted.

FIG. 6 depicts in a representative form, a more detailed diagram of a portion of the correction factor calculator for determining a correction factor suitable for use in FIG. 2 in accordance with one or more embodiments. FIG. 6 illustrates a fillbits or Null bit or element calculator 603. Given the inputs N_D at 305, the bit stream index at 311, and the permuted column, pcol at 407 corresponding to a desired sample or specific data element, dk at 303, we can calculate or determine how many Null elements or dummy bits were before or in front of the specific data element in the building of the circular buffer (available at the output). Various embodiments of how to compute or calculate the number of fill-bits will be provided below.

FIG. 7-9 depicts in a representative form more detailed diagrams of respective portions of the correction factor calculator suitable for use in FIG. 6 in accordance with one or more embodiments. Referring to FIG. 7, a first portion of the fillbit function 603 for the correction factor calculator and calculations is illustrated. In FIG. 7, the apparatus is setting a flag for each column that preceded a permuted column. By way of example suppose pcol=2. In table 5.1.4-1 in the E-UTRA standards or in the listing above with reference to FIG. 4, one notes that the 2^{nd} permuted column was preceded in transmission by pre-permuted columns 0 and 16 and that the 2^{nd} permuted column maps to pre-permuted column 8. So the FIG. 7 logic or function is setting a flag high for each pre-permuted column and for each column that preceded it in transmission. Thus FIG. 7 illustrates where wherein the calculating a correction factor further comprises finding, for a column corresponding to the specific data element, all pre-permuted columns that preceded the column in reception and the column.

This is reflected in FIG. 7 as a sequence of comparators 703 coupled to a sequence of OR gates 705 which are intercoupled and operate to select the equality that is satisfied by pcol from 407. In the example above with pcol=2 it is noted that comparator 707=2 would be true or positive and thus OR gate 709 would be positive resulting in OR gates 711 and 713 being positive. The outputs of the OR gates from top to bottom are in the order of the listing noted above, i.e., <0, 16, 8, . . . , 7, 23, 15, 31>. Given the example, it will be evident, how the remainder of the logic in FIG. 7 operates with various values for pcol.

Referring to FIG. 8 a second portion of the fillbit function 603 for the correction factor calculator and calculations is illustrated. The logic or apparatus of FIG. 8 creates a flag for each integer from 1 to 31, where N_D is greater than that integer. This is done by a sequence of comparators 803 coupled to a sequence of OR gates 804 which are intercoupled and operate to select or identify what integer is equal to N_D at 305 (one of the common air interface parameters also used for the offset address determination or calculation) and that comparator operates to cause a corresponding OR gate to go positive which results in all higher position OR gates going positive. By way of example, suppose N_D is equal to 3, then comparator 805 (=3) will go positive causing OR gate 807 to go positive (setting flag N_D>2) and thus all higher OR gates go positive, specifically OR gates 809, 811 go positive. Thus 3 flags are set and these are identified, respectively, as N_D is gt than 2, 1, and 0. This information can be used to limit the summing of dummy bits to no more than N_D in the FIG. 9 logic. Thus FIG. 8 illustrates where the calculating a correction factor further comprises setting flags that correspond to the number of null elements.

Referring to FIG. 9 a final portion of the fillbit function 603 for the correction factor calculator and calculations is illustrated. The apparatus or logic illustrated in FIG. 9, given the flags 803 created from the apparatus or logic in FIG. 7, 8, and bit stream at 311 (just a logic low or 0 for bit stream 0 and logic high or 1 for bit stream 1 or 2) utilizing a collection of AND gates 905 and summers 907, etc. arranged and intercoupled as depicted, sums up and provides at the output 909 of multiplexer 911, a total number of Null elements or dummy bits for a given column. As an example, take col=31. With col=31, the apparatus in FIG. 7 sets every pcol_ge_p<n> flag (since pre-permuted it's still 31, meaning that all columns proceeded it). Therefore in FIG. 9, all the 2 input AND gates with one input coupled to pcol_ge_p<n> and the other input coupled to an N_D_gt_<n> are set high. So if N_D=3 and bit stream=0 at 311, three of the AND gates 913, 915, 917 are active or positive and the summers 919, 921, and 923 sum a total of three dummy bits, which is output from multiplexer 911 while bit stream is 0.

Take the same example but set bit stream=1 or 2 at 311. Recall that all of the bit stream 0 bits or data elements are placed in the circular buffer before any of the bit stream 1 or 2 data elements. The correction factor needs to account for and thus the calculation determines the number of dummy or filler bits or data that are in the circular buffer ahead of the specific data element. If bit stream 0, i.e., bit stream is positive or 1, 2, then all the dummy bits of bit stream 0, (N_D), have proceeded the specific data element. This is accomplished with the summer 925 which adds N_D dummy or filler bits at 305 and this is output by the multiplexer 911 when bit stream 1, 2 is present at 311.

Additionally when bit stream≠0, i.e., for bit stream 1, 2, additional AND gates 927, 929, etc. are provided. These are used to account for bit streams 1 and 2 alternating. So for each column that was transmitted before a given column, we had a column's worth of contribution from bit stream 1 and a column's worth of contribution from bit stream 2. But also note that there is a shift in the comparisons to compensate for the shift in bit stream 2. As an example, let's say we're only looking at col=0. Because of the shift of bit stream 2, the first column of the pre-permuted matrix won't contain a dummy bit if N_D was 1. Therefore, we see that the 3-input AND gate 927 ANDs pcol_ge_p0 with N_D_gt_{—}1 and the 3-input AND gate 929 ANDs pcol_ge_p1 with N_D_gt_{—}2. With the above and from the discussions below, we're able to calculate the number of fillbits that proceeded a given index into the circular buffer.

FIG. 10 depicts a more detailed diagram of an output portion of the correction factor calculator in accordance with one or more embodiments; The fillbits function 603 as illustrated in FIG. 7-9 calculates the number of fill bits at 909 that proceeded a given index in the circular buffer. However as noted above, the system may not start transmitting samples at the start of the circular buffer. Transmission starts at k0, which can change for different transmissions. A constant (Fillbits_k0) at 1001 is calculated usually once for each transmission and this is used by the subtractor 1003 to provide a correction of the dummy bits at 1005 given that you don't start at the beginning of the circular buffer.

Furthermore, for each k0, as discussed above (see FIG. 5 discussion) a modulo arithmetic adjustment to account for truncation of the circular buffer or transmit data sequence to Ncb locations was performed in the main path. When we make a modulo adjustment, we need to account for what that does in the total for dummy bits. For example, where is the first bit (i=0) that was used to build the circular buffer. Continuing, suppose k0 is non zero, i.e, k0=1. That means that i=0, possibly the first bit in the circular buffer, will be the last bit from the circular-buffer to be transmitted (i−k0=−1, j=(i−k0) mod Ncb=Ncb−1: the last index). Therefore, Ncb-1 bits proceeded it, which means all the dummy bits of Ncb proceeded it too. So we add, using adder 1007, a second constant (fillbits_Ncb) worth of fillbits at 1009 to the output 1005 and the result is passed by the multiplexer 1011 to the output 519 when the modulo is performed as reflected by the control signal provided from the offset address calculator at 515. The correction factor at output 519 is passed to FIG. 5 and used as noted above for adjusting for any impact on the offset address resulting from null elements. Thus calculating the correction factor in some embodiments includes using one or more constants (constant for a transmission) that correspond to a count of null elements when the specific data element is the starting data element for transmission (dk=k0) and when the specific data element is the last data element in a sequence to be transmitted (dk=Ncb).

The perl program below can be used to calculate the constants noted above, specifically fillbits_k0 and fillbits_Ncb. Note that these constants do not change over an entire transmission, i.e., Ncb data elements or bits. These constants give the number of fill or dummy bits or Null elements, if the corresponding k0 or Ncb was taken as the designated data element or said another way the portion of the total number of Null elements or filler bits for a given column in the interleaved matrix for a given number of total Null elements

```
$fillbits_k0 = FillbitsAddr( $k0, $N_D, $K_Pi, $R_TC_subblock );
$fillbits_Ncb = FillbitsAddr( $Ncb, $N_D, $K_Pi, $R_TC_subblock );
  sub FillbitsAddr ($$$$) {
    my ( $addr, $N_D, $K_Pi, $R_TC_subblock ) = @_;
    my $fillbits = 0;
    while( $addr ) {
            if( $addr < $K_Pi ) {
              my $col = floor(($addr-1)/$R_TC_subblock);
              $fillbits += FillbitsColInclusive( $col, $N_D, 0);
              $addr = 0;
            } else {
              $fillbits += $N_D;
              $addr -= $K_Pi;
            }
            if( $addr < 2*$K_Pi ) {
              my $p = floor($addr/2) + ($addr%2);
              my $q = floor($addr/2);
              my $pcol = floor(($p-1)/$R_TC_subblock);
              my $qcol = floor(($q-1)/$R_TC_subblock);
              $fillbits += FillbitsColInclusive( $pcol, $N_D, 1);
              $fillbits += FillbitsColInclusive( $qcol, $N_D, 2);
              $addr = 0;
            } else {
              $fillbits += 2*$N_D;
              $addr -= 2*$K_Pi;
              }
      }
      return $fillbits;
    }
    # Note: P[ ] is permutation matrix of the interleaver
    sub FillbitsColInclusive ($$$) {
      my ( $col, $N_D, $bitstream ) = @_;
      my $fillbits = 0 ;
      $fillbits = 0;
      for( my $n = 0 ; $n <= $col ; $n++) {
          if( $P[$n] < ($N_D-($bitstream==2)) ) {
            $fillbits++;
          }
        }
        return $fillbits;
    }
```

Referring to FIG. 11 a flow chart of processes executed by a method of address or index generation that may be used in conjunction with the FIG. 2 system in accordance with one or more embodiments will be briefly discussed and described. FIG. 11 illustrates a representative embodiment of a method of address or index generation for one or more locations in a buffer with received data in accordance with one or more embodiments. It will be appreciated that this method uses many of the inventive concepts and principles discussed in detail above and thus this description will be somewhat in the nature of a summary with various details generally available in the earlier descriptions. This method can be implemented in one or more of the structures or apparatus described earlier or other similarly configured and arranged structures.

The method of address or index generation for one or more locations in a buffer with received data starts at 1100 and then determines 1103 an offset address for a specific data element in the buffer, using various parameters related to the air interface and communications. Then the method includes calculating 1105 a correction factor separately from and in some embodiments in parallel with the determining an offset address again using some of the various parameters and other constants. Afterwards, the method includes providing 1107 an address or index for the specific data element in the buffer by combining the offset address and the correction factor, where the correction factor adjusts for any impact on the offset address resulting from null elements. The method then ends at 1109. It will be appreciated that the method can be repeated as often and as needed.

Generally for each transmission, the fillbit constants are calculated and then the index or address specifying the location in the received data buffer for each transmitted bit or data element will need to be determined and thus the method in FIG. 11 or various embodiments thereof and as further discussed and described variously with reference to FIGS. 1-10 would be repeated for each specific data element or dk. These indexes or addresses would be found prior to needing to access that particular data element; however would not necessarily need to all be found prior to other decoding efforts.

It will be appreciated that the above described functions and structures may be implemented in one or more integrated circuits as hardware or software or some combination of both and of course may be implemented along with various other functions in the same hardware, etc. It may be appropriate to implement the functions and features in decoders for wireless communication devices where the decoders do many functions in addition to those described.

The processes, apparatus, and systems, discussed above, and the inventive principles thereof are intended to and can alleviate power consumption and time delay issues caused by prior art de-interleaving or decoding techniques. Using these principles determining an offset address and in parallel a correction factor and combining these to arrive at or for determining an address or index for data values in a receive data buffer and this to retrieve data as needed can quickly result in de-interleaved data with relatively minimal costs in terms of energy consumption or processor capacity and the like.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A method of address generation for one or more locations in a buffer with received data, the method comprising:
determining an offset address for a specific data element in the buffer;
calculating a correction factor separately from the determining an offset address; and
providing an address for the specific data element in the buffer by combining the offset address and the correction factor, the correction factor adjusting for any impact on the offset address resulting from null elements.

2. The method of address generation for one or more locations in a buffer with received data of claim 1 wherein the determining an offset address and the calculating a correction factor each utilize one or more of the same parameters.

3. The method of address generation for one or more locations in a buffer with received data of claim 2 wherein the one or more of the same parameters further comprises parameters specified in accordance with an air interface standard.

4. The method of address generation for one or more locations in a buffer with received data of claim 2 wherein the one or more of the same parameters further comprises parameters in accordance with a message received from an air interface communication.

5. The method of address generation for one or more locations in a buffer with received data of claim 1 wherein the determining an offset address and calculating a correction factor each use a common control signal.

6. The method of address generation for one or more locations in a buffer with received data of claim 1 wherein the determining an offset address further comprises specifying the position of the specific data element in a sequence and a total count of null elements and finding the offset address as though each of the null data elements were in the buffer.

7. The method of address generation for one or more locations in a buffer with received data of claim 6 wherein the determining an offset address further comprises selecting the sequence from a plurality of sequences.

8. The method of address generation for one or more locations in a buffer with received data of claim 6 wherein the determining an offset address further includes compensating for a starting point for transmitted data to selectively adjust the offset address.

9. The method of address generation for one or more locations in a buffer with received data of claim 1 wherein the providing an address for the specific data element in the buffer by combining the offset address and the correction factor, further comprises determining whether a possible address corresponds to a transmitted data element.

10. The method of address generation for one or more locations in a buffer with received data of claim 1 wherein the calculating a correction factor further comprises using one or more constants that correspond to a count of null elements when the specific data element is in a, respective, one or more predetermined locations.

11. The method of address generation for one or more locations in a buffer with received data of claim 10 wherein the calculating a correction factor further comprises using one or more constants that correspond to a count of null elements when the specific data element is in the starting location for transmission (dk=k0) and when the specific data element is in the last data element in a sequence to be transmitted (dk=Ncb).

12. The method of address generation for one or more locations in a buffer with received data of claim 1 wherein the calculating a correction factor further comprises finding, for a column corresponding to the specific data element, all pre-permuted columns that preceded the column in reception.

13. The method of address generation for one or more locations in a buffer with received data of claim 1 wherein the calculating a correction factor further comprises setting flags that correspond to a total number of null elements.

14. The method of address generation for one or more locations in a buffer with received data of claim 1 wherein the calculating a correction factor further comprises summing the number of null elements given a total number of null elements, a sequence corresponding to the specific data element, and a column corresponding to the specific data element.

15. The method of address generation for one or more locations in a buffer with received data of claim 1 wherein the calculating a correction factor further comprises adjusting the number of Null elements that correspond to the correction factor for the specific data element given a starting point for transmission and given any truncation of the data sequence.

16. An address generator for index generation, where the index corresponds to locations in a buffer with received data, the address generator comprising:
an offset address function for determining an offset address for a specific data element in the buffer;
a correction factor calculator for calculating a correction factor separately from the determining an offset address; and
a combiner arranged for providing an index corresponding to the specific data element in the buffer by combining the offset address and the correction factor, the correction factor adjusting for any impact on the offset address resulting from null elements.

17. An address generator for index generation of claim 16 wherein the offset address function and the correction factor calculator each utilize one or more of the same parameters for their respective operations and wherein these parameters are based on an air interface communication.

18. An address generator for index generation of claim 16 wherein the offset address function and the correction factor calculator each utilize a common control signal.

19. An address generator for index generation of claim 16 wherein the determining an offset address further comprises specifying the position of the specific data element in a sequence and a total count of null elements and finding the offset address as though each of the null data elements were in the buffer.

20. An address generator for index generation of claim 16 wherein the calculating a correction factor further comprises using one or more constants that correspond to a count of null elements when the specific data element is the starting data element for transmission (dk=k0) and when the specific data element is the last data element in a sequence to be transmitted (dk=Ncb).
